(19) United States
(12) Patent Application Publication
(10) Pub. No.: US 2018/0334000 A1
(43) Pub. Date: Nov. 22, 2018

(54) AMPHIBIOUS BOATS

(71) Applicant: Adriatic Machine and Tool Ltd., Mississauga (CA)

(72) Inventor: Ranko Lazarevis, Mississauga (CA)

(21) Appl. No.: 15/984,962

(22) Filed: May 21, 2018

Related U.S. Application Data
(63) Continuation-in-part of application No. PCT/CA2017/050067, filed on Jan. 23, 2017.
(60) Provisional application No. 62/508,416, filed on May 19, 2017.
(60) Provisional application No. 62/448,133, filed on Jan. 19, 2017.
(60) Provisional application No. 62/281,966, filed on Jan. 22, 2016.
(60) Provisional application No. 62/301,160, filed on Feb. 29, 2016.
(60) Provisional application No. 62/292,950, filed on Feb. 9, 2016.

(51) Int. Cl. B60F 3/00; B63C 13/00

(52) U.S. Cl. CPC B60F 3/0069; B60D 1/06; B63C 13/00

(57) ABSTRACT

A system is provided that includes a boat; a pair of wheels; for each wheel, an arm to which said each wheel is rotatably mounted, the arm being movable between towing and water configurations. In the towing configuration, the boat is supported for rolling movement on the wheels when dragged from the bow of the boat. In the water configuration the wheels are alongside the boat; and means for coupling the boat to a vehicle, such as a hitch are provided.

### RELATED APPLICATIONS

This application is a non-provisional application that claims priority benefit to U.S. Provisional Application Ser. No. 62/508,416; filed May 19, 2017, and is also a continuation-in-part of PCT/CA2017/050067; filed Jan. 23, 2017, that in turn claims priority benefit to U.S. Provisional Application Ser. No. 62/448,133; filed Jan. 19, 2017; U.S. Provisional Application Ser. No. 62/281,966; filed Jan. 22, 2016; U.S. Provisional Application Ser. No. 62/301,160; filed Feb. 29, 2016; and U.S. Provisional Application Ser. No. 62/292,950; filed Feb. 9, 2016; the contents of the aforementioned applications are incorporated herein by reference.

### FIELD OF THE INVENTION

The invention relates to the field of amphibious boats.

### BACKGROUND OF THE INVENTION

Amphibious boats are well known but known amphibious boats are relatively costly to manufacture or cumbersome to operate in consideration of functionality.

### SUMMARY OF THE INVENTION

Forming one aspect of the invention is a system including: a boat; a pair of wheels; for each wheel, an arm to which said each wheel is rotatably mounted, the arm being movable between: (i) a towing configuration, wherein, when operatively positioned, the boat is supported for rolling movement on the wheels when dragged from the bow; and (ii) a water configuration, wherein, when operatively positioned, the wheels are alongside the boat; and means for coupling the boat to a vehicle.

Advantages, features and characteristics of the invention will become evident upon a review of the detailed description with reference to the accompanying drawings, the latter being briefly described hereinafter.

### BRIEF DESCRIPTION OF THE DRAWINGS

FIG. 1 shows the components of a system according to an exemplary embodiment of the invention;

FIG. 2 is a top perspective view of a portion of the structure of FIG. 1;

FIG. 3 is a bottom perspective view of the structure of FIG. 2;

FIG. 4 is a top view of the structure of FIG. 2;

FIG. 5 is a bottom view of the structure of FIG. 2;

FIG. 6 is a front view of the structure of FIG. 2;

FIG. 7 is a rear view of the structure of FIG. 2;

FIG. 8 is a view of the components of FIG. 1 assembled for use;

FIG. 9 is a view of the structure of FIG. 8 in use with a vehicle;

FIG. 10 is a side view of the structure of FIG. 9;

FIG. 11 is a view similar to FIG. 10, with the structure of FIG. 2 decoupled from the balance of the structure;

FIG. 12 is a view of the structure of FIG. 11 with a portion of the tongue pivoted for storage;

FIG. 13A is a side view of the structure of FIG. 2 in the towing configuration;

FIG. 13B is an enlarged perspective view of the structure of FIG. 13A;

FIG. 13C is a view along section 13C-13C of FIG. 13B;

FIG. 14A is a side view of the structure of FIG. 2 in the towing configuration;

FIG. 14B is an enlarged perspective view of the structure of FIG. 13A;

FIG. 14C is a view along section 13C-13C of FIG. 13B;

FIG. 15A is a side view of the structure of FIG. 2 in the towing configuration;

FIG. 15B is an enlarged perspective view of the structure of FIG. 13A;

FIG. 15C is a view along section 13C-13C of FIG. 13B;

FIG. 16A is a side view of the structure of FIG. 2 in the towing configuration;

FIG. 16B is an enlarged perspective view of the structure of FIG. 13A;

FIG. 16C is a view along section 13C-13C of FIG. 13B;

FIG. 17A is a side view of the structure of FIG. 2 in the towing configuration;

FIG. 17B is an enlarged perspective view of the structure of FIG. 13A;

FIG. 17C is a view along section 13C-13C of FIG. 13B;

FIG. 18A is a side view of the structure of FIG. 2 in the towing configuration;

FIG. 18B is an enlarged perspective view of the structure of FIG. 13A;

FIG. 18C is a view along section 13C-13C of FIG. 13B;

FIG. 19 is a top perspective view of the structure of FIG. 18A;

FIG. 20 is a bottom perspective view of the structure of FIG. 19;

FIG. 21 is an exploded view of the structure of FIG. 20;

FIG. 22 is a sectional view of the structure of FIG. 2;

FIG. 23 shows hull lines for the structure of FIG. 2;

FIG. 24 shows hull lines for the structure of FIG. 2;

FIG. 25 is a perspective view of a variant of the structure of encircled area 125 of FIG. 1;

FIG. 26 is a side view of the structure of FIG. 25;

FIG. 27 is a front view of the structure of FIG. 25; and

FIG. 28 is a perspective view of a variant of the structure of encircled area 128 of FIG. 1.

### DETAILED DESCRIPTION

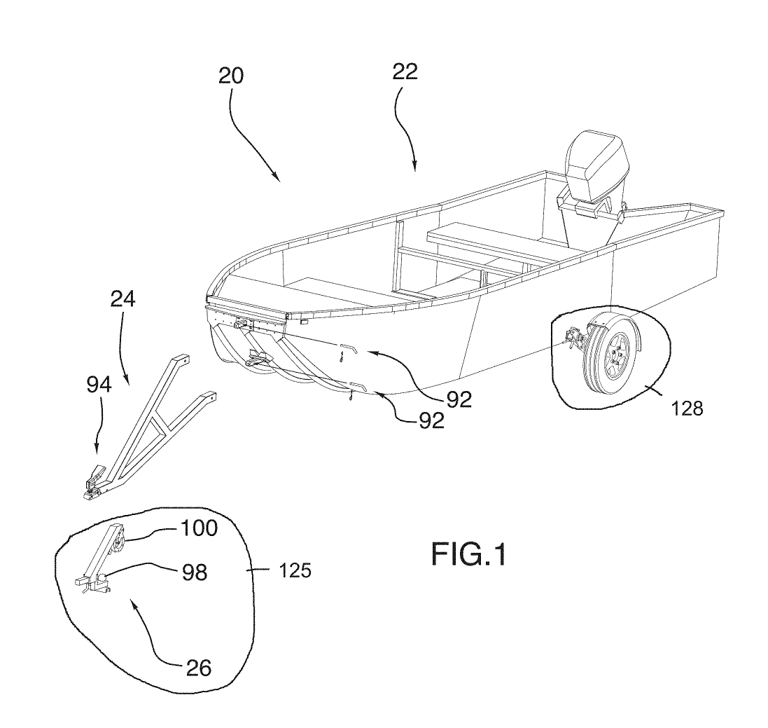

The components of the exemplary system 20 shown in FIG. 1 will be seen include an amphibious boat 22, a tongue 24 and a hitch arrangement 26.

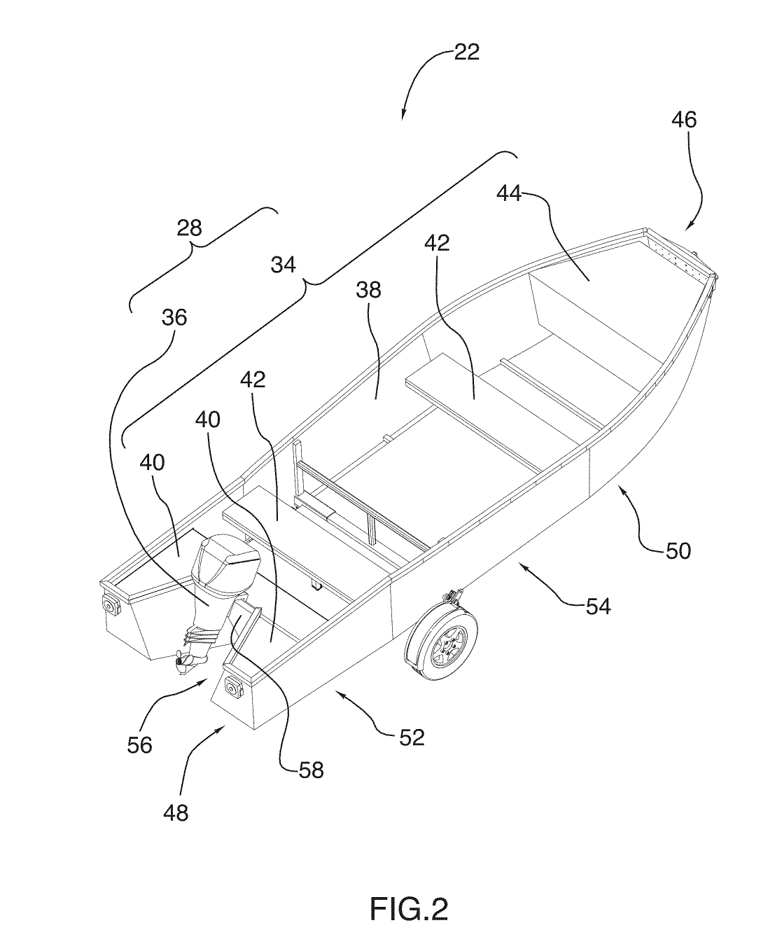

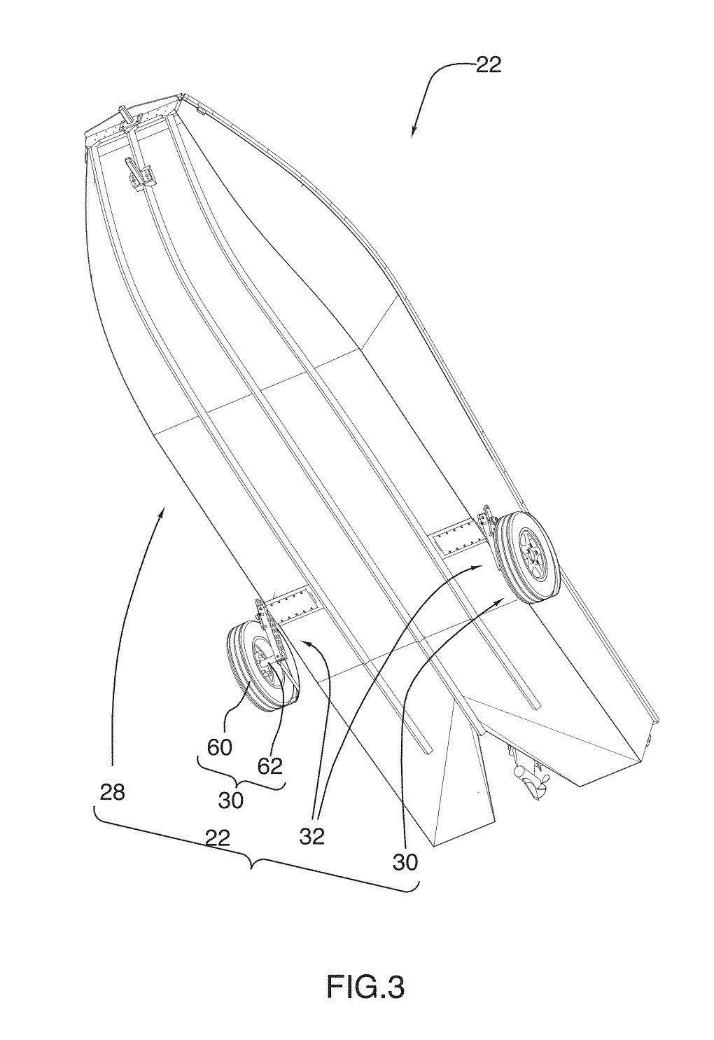

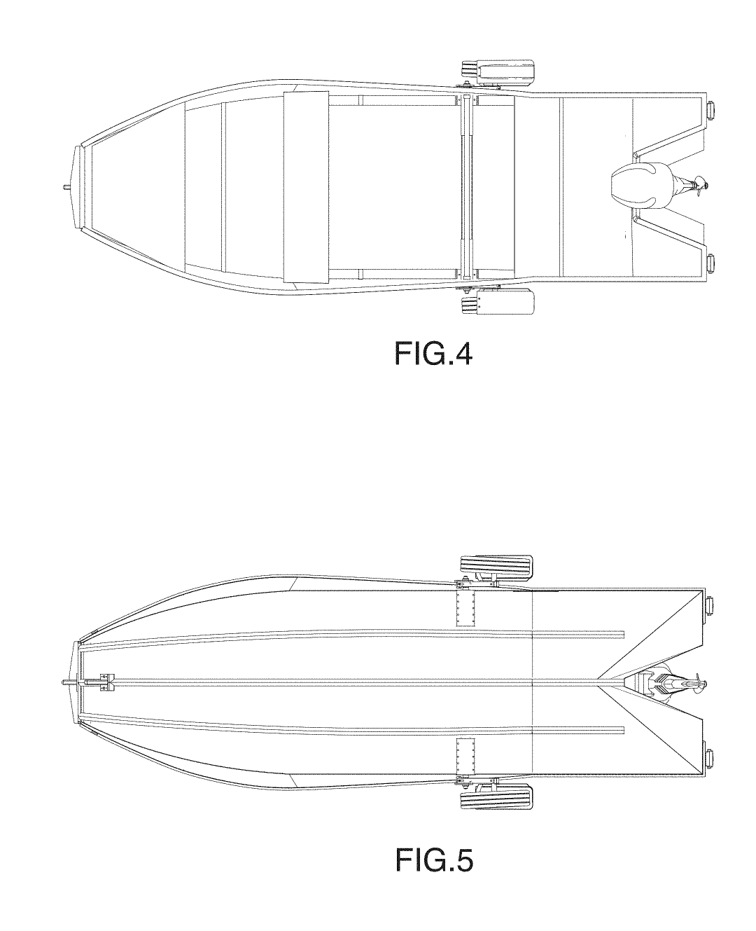

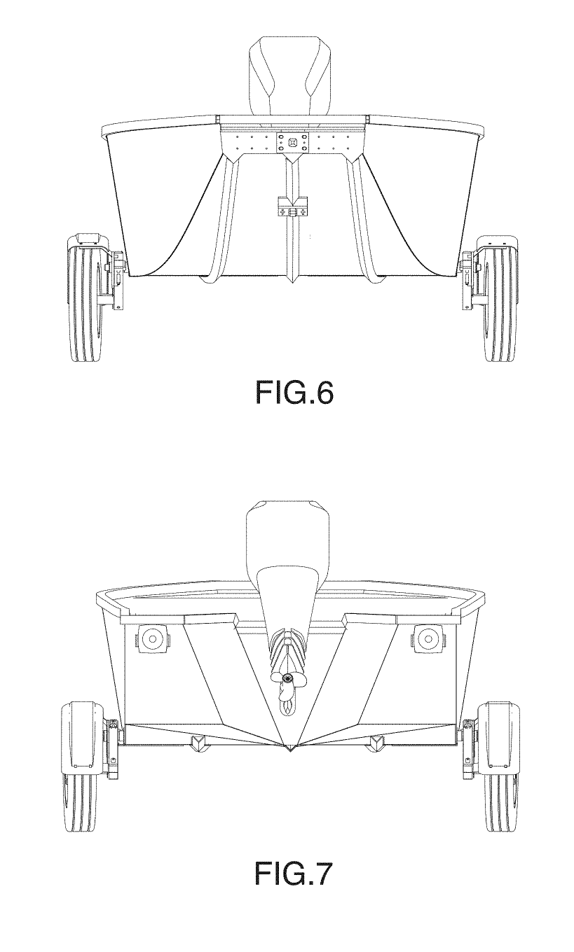

The amphibious boat 22 is shown in FIG. 2-8 and will be seen to include: a boat 28; a pair of wheel assemblies 30 and a coupling arrangement 32.

The boat 28 includes a body 34 and an outboard motor 36.

The body will be seen to include: a hull 38, a pair of stern seats 40, a pair of intermediate seats 42 and a bow seat 44.

The hull has: a bow 46 and a stern 48; a relatively wide portion 50 including the bow; a relatively narrow portion 52 including the stern; a transition portion 54 that narrows as it connects the bow portion to the stern portion; at the stern, a well 56 having a transom 58 disposed aft of the transition portion.

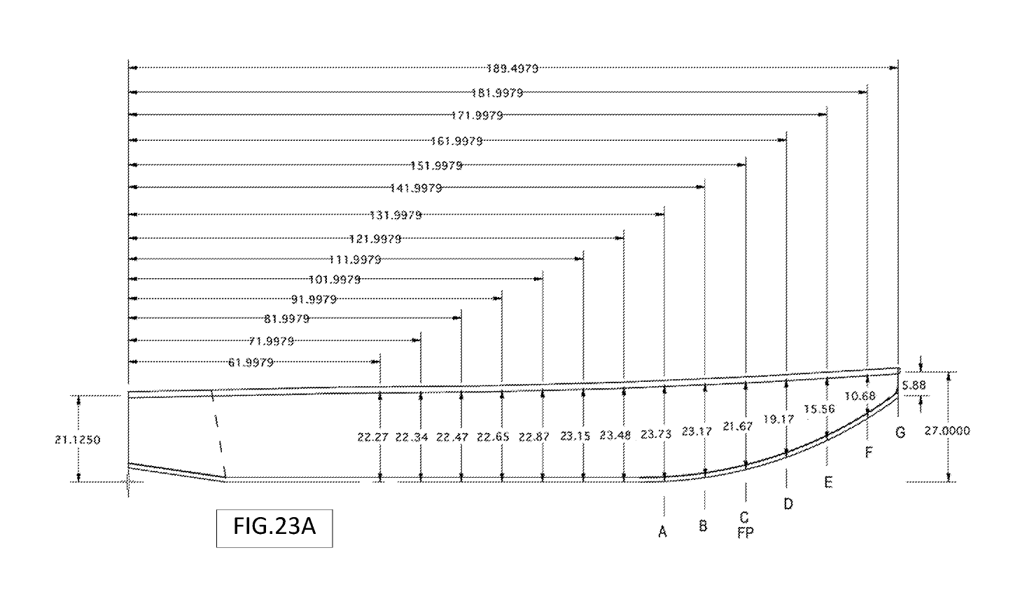

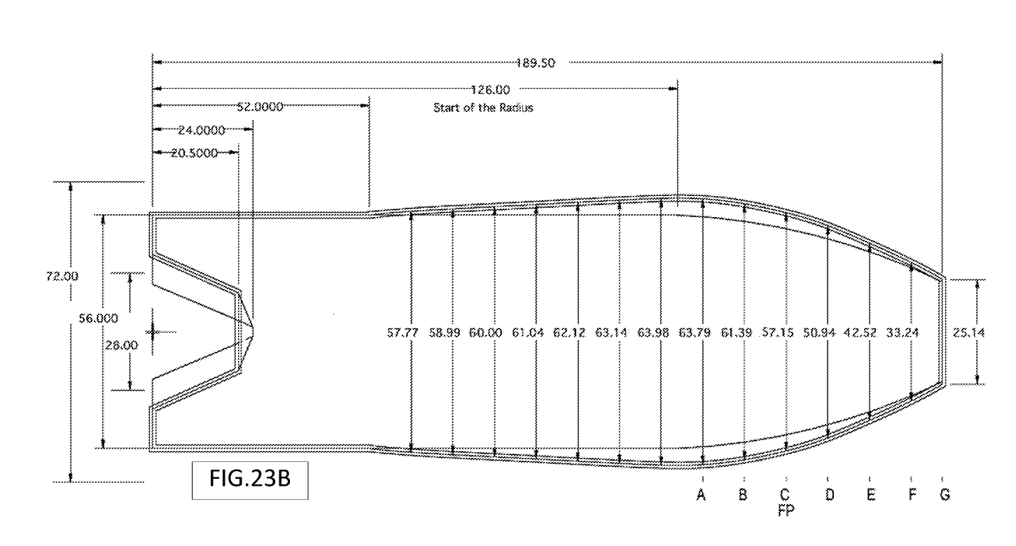

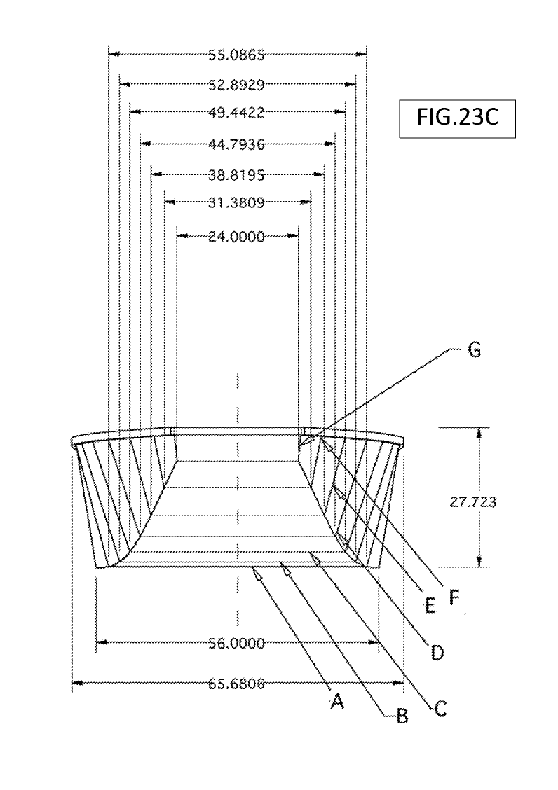

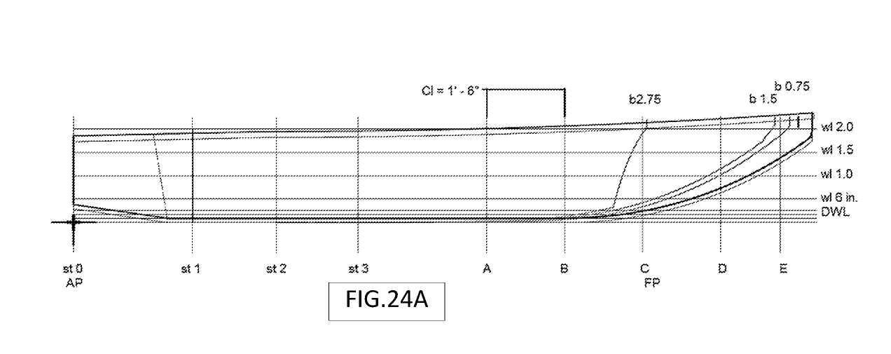

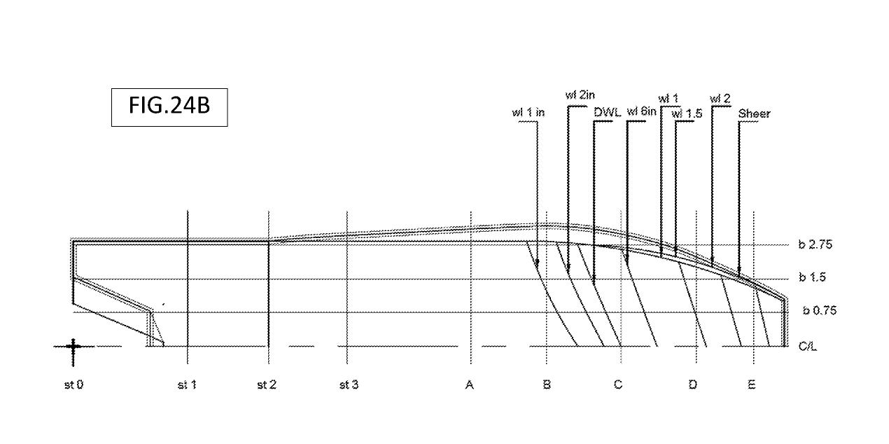

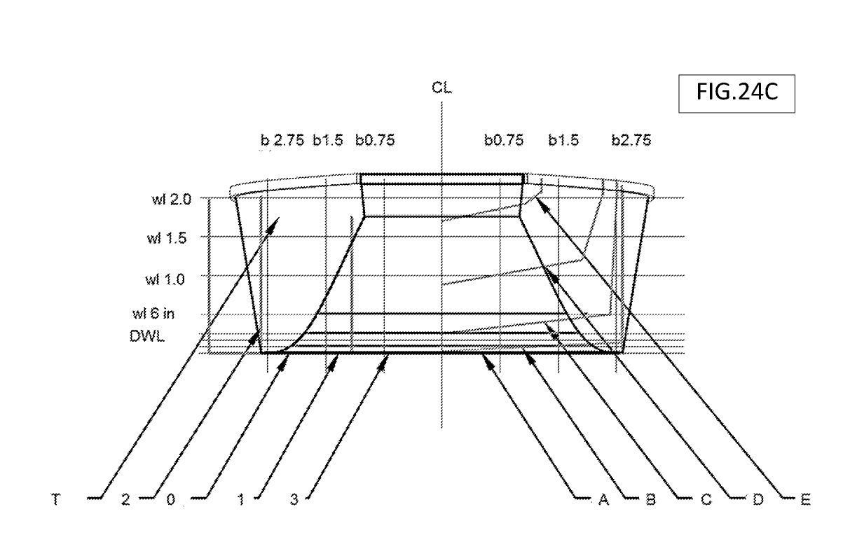

FIGS. 23-24 show lines for the hull from which persons of ordinary skill will readily appreciate that the hull is shaped to be seaworthy.

As best seen in FIG. 2:

the stern seats are disposed aft of the transom and in flanking relation to the well and are filled with a buoyant foam. A suitable foam is that sold under the trademark POLARFOAM which has a density of 40 kg/m3.

the intermediate seats are disposed in the transition portion.

the bow seat is disposed adjacent and in spaced relation to the bow and forward of and in spaced relation to the intermediate seats and is similarly filled with buoyant foam.

The outboard motor is, in use, mounted to the transom, as indicated in FIG. 2.

The wheel assemblies are of a conventional type which have a wheel 60 rotatably mounted to a pintle 62.

The coupling arrangement includes, for each wheel: a bolt 64; a pin 66; an arm 68; a capture plate 69; a spring mount 70 and a guide plate 72.

The bolt has head 73, a smooth shaft 74 extending from the head and a threaded end 76.

The pin is a quick release ball lock pin.

The arm is a drilled aluminum bar which is in receipt of the pintle and also has

a. an end portion 74 in which a throughbore 75, a smooth bore 76 and a partially threaded bore 78A, 78B are defined, the partially threaded bore terminating in a hollow 79, the throughbore 75 intersecting smooth bore 76
b. a slot 80 that: defines a pair of forks 82A,82B; bisects the smooth bore 76 radially; and that bisects the partially threaded bore longitudinally, such that one 82A of the forks has a threaded part 78A of the partially threaded bore and the other 82B of the forks has a non-threaded part 78B of the partially threaded bore

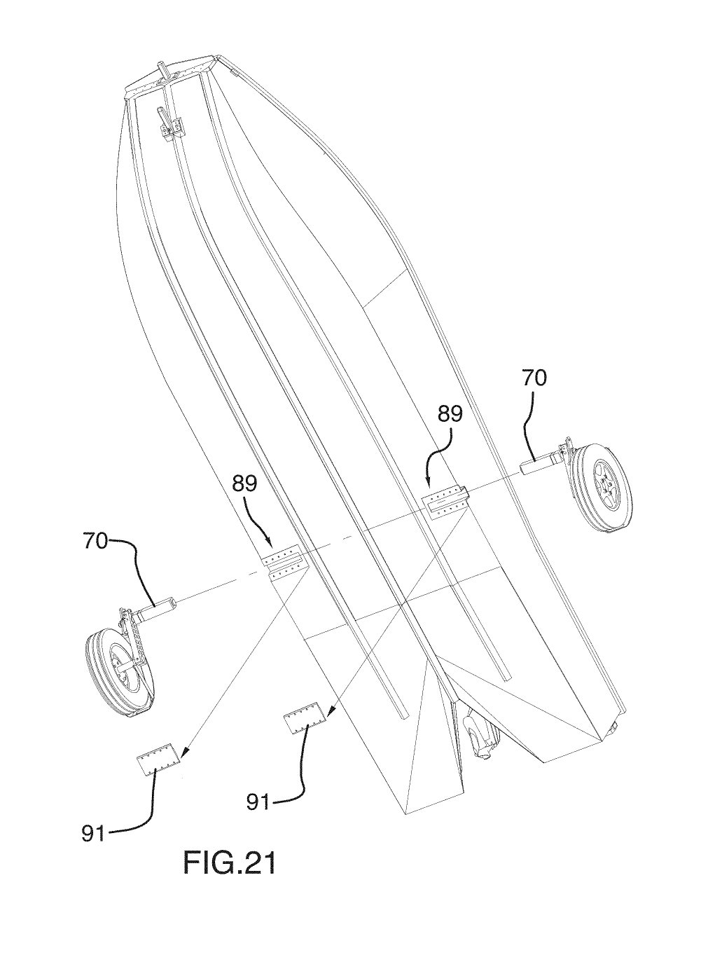

The spring mount includes an elastic member 86 releasably mounted to the hull and a shaft 88 securely gripped by the elastic member to protrude from the hull, the shaft having an aperture 89 defined therethrough. The sequence of FIGS. 20 and 21 show the manner in which the spring mounts are so releasably received, namely, recesses 89 are defined in the hull which are adapted to receive the spring mounts, and plates 91 are provided which bolt to the hull and capture the spring mounts.

The guide plate 72 has a pair of stop bars 90A,90B and is rigidly secured to the shaft 88.

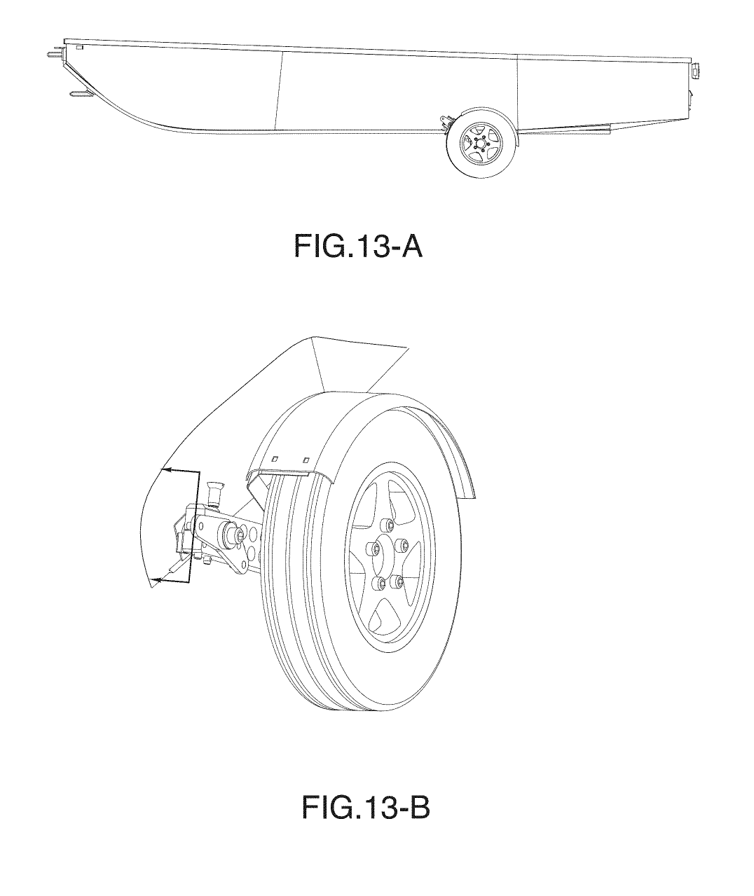

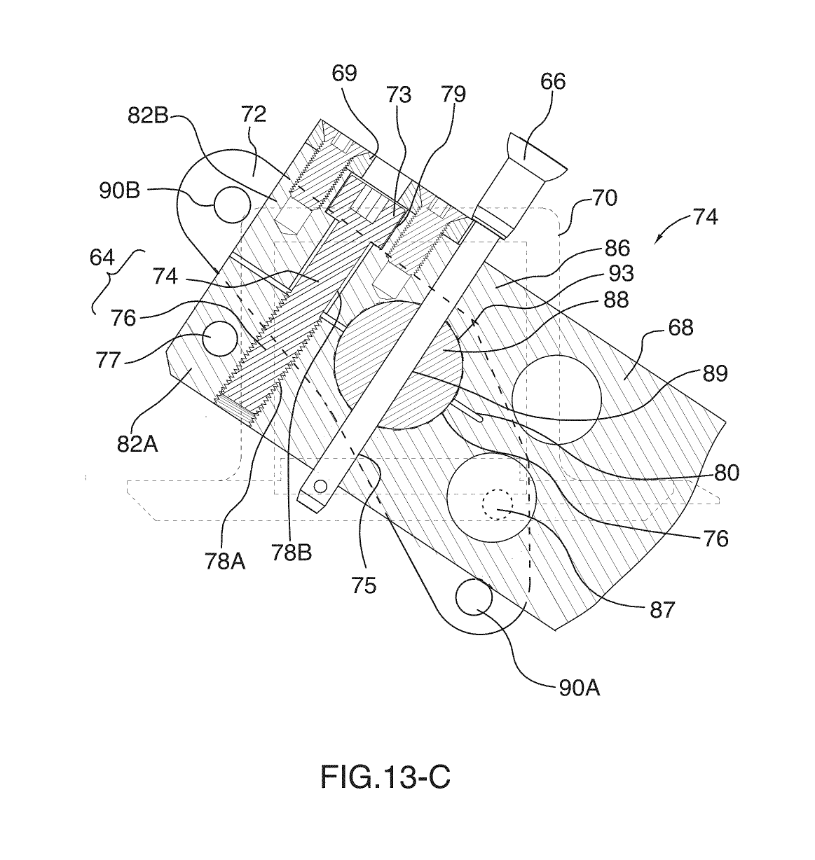

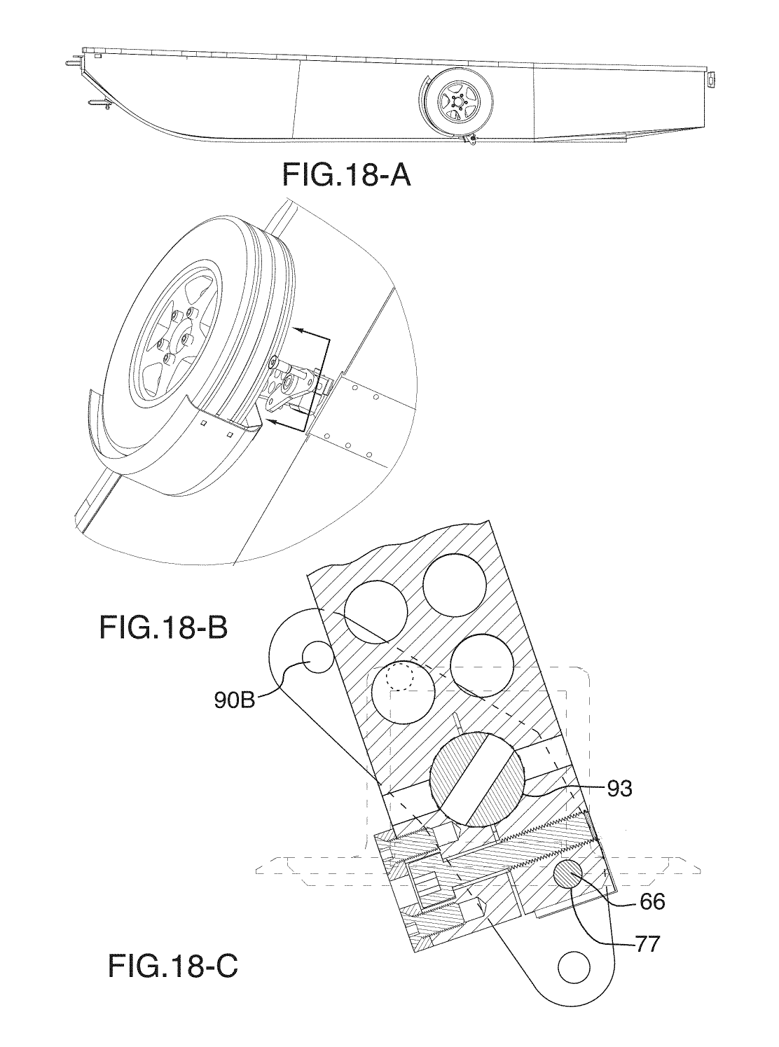

The coupling arrangement provides for movement of the arms between:
a towing configuration, as shown in FIG. 13A-C, wherein, when operatively positioned, the hull is supported for rolling movement on the wheels when dragged from the bow; and
a water configuration, as shown in FIGS. 18A-C, wherein, when operatively positioned, the wheels are alongside the hull, for boating.

The manner in which such movement is provided will become evident upon review of the sequence of FIGS. 13A-18C.

As indicated, FIG. 13A-13C shows the towing configuration. In this configuration, the pin 66 extends through the aperture 89 in the shaft and the throughbore 75; the fork ends 82A,82B are drawn together by the bolt 64; and the bolt head 73 is captured in the hollow 79 by the capture plate 69. This causes the arm to project downwardly and rearwardly from the shaft. It is notable in this regard that the arm rests against stop bar 90A.

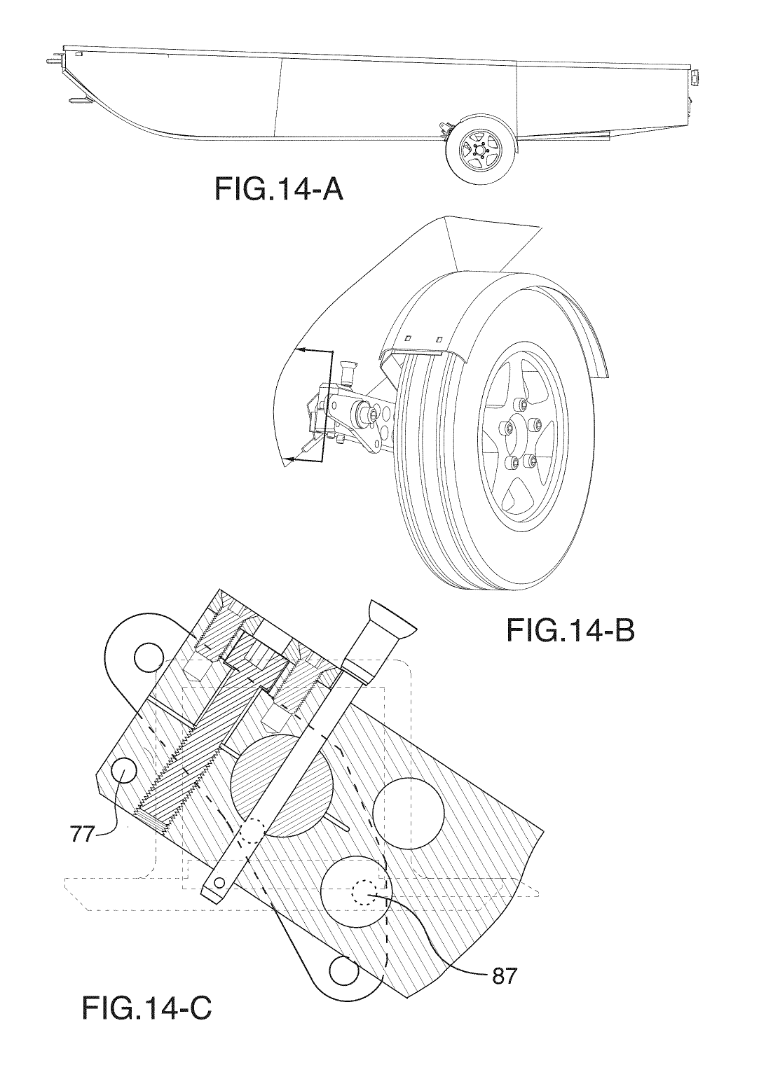

A first step in the movement involves a slight loosening of the bolt, to allow the forks to spread apart, all as shown in FIGS. 14A-14C. It is noted that the bolt cannot be removed entirely, since it is restrained by the capture plate 69.

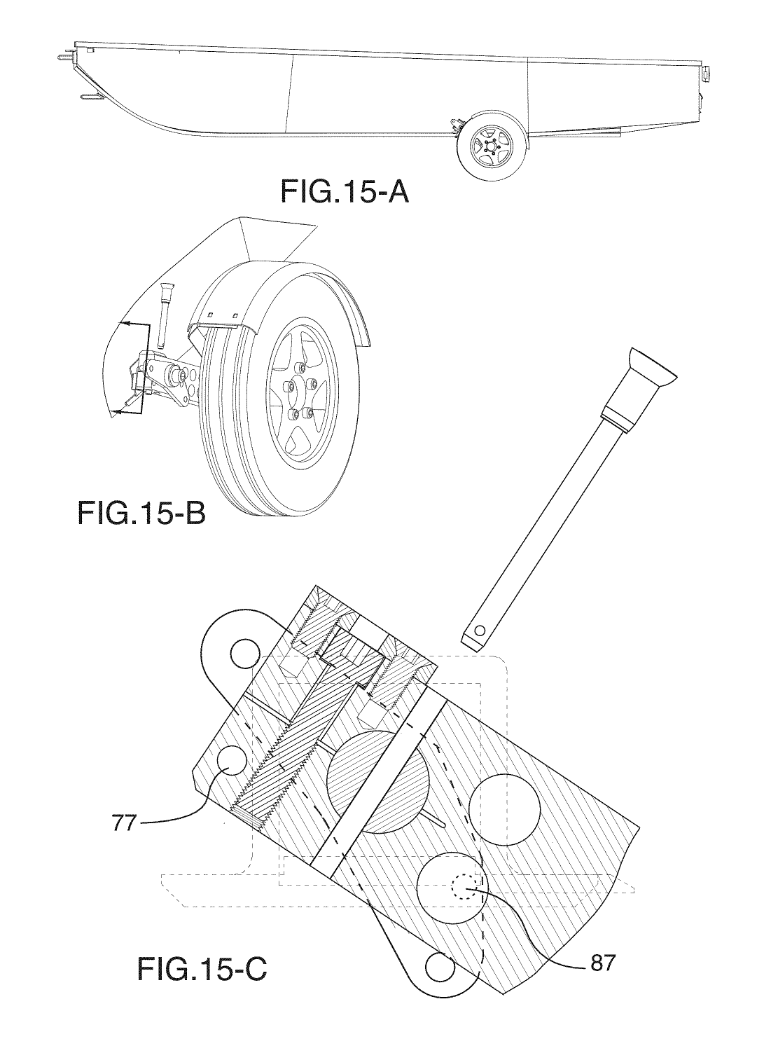

A second step in the movement involves removal of the spring pin, as shown in FIGS. 15A-15C.

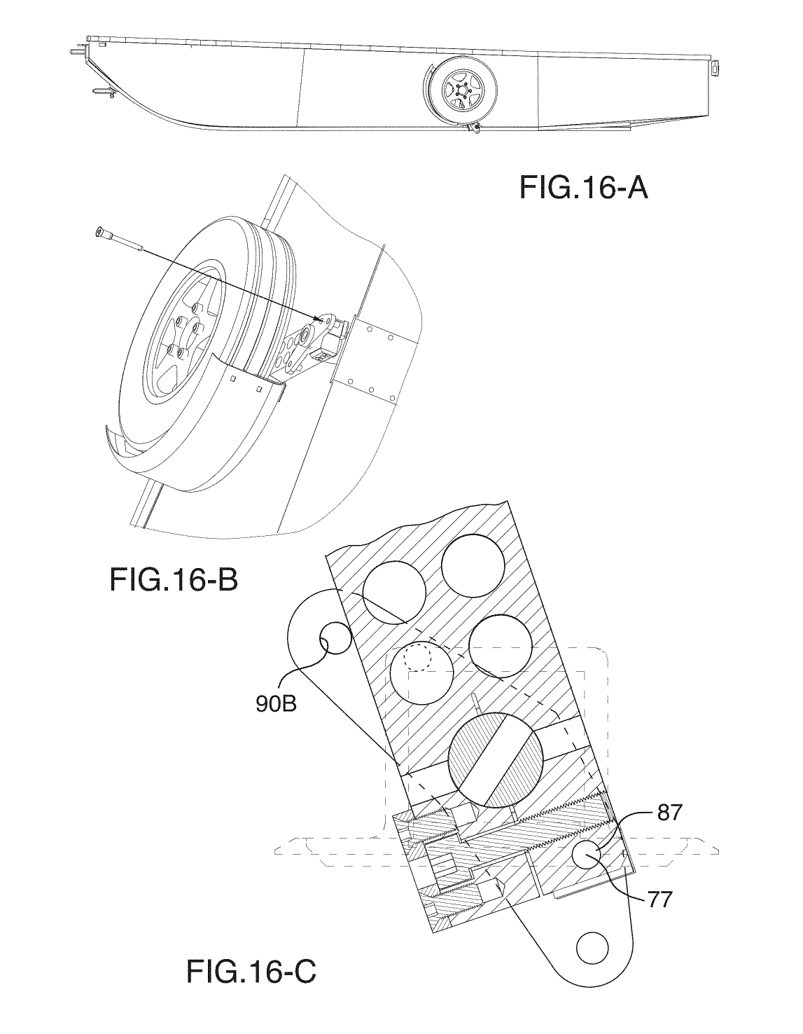

With the pin so removed, the arm can be pivoted until such time as the arm engages the second stop bar 90B, as shown in FIGS. 16A-16C, which defines the water configuration.

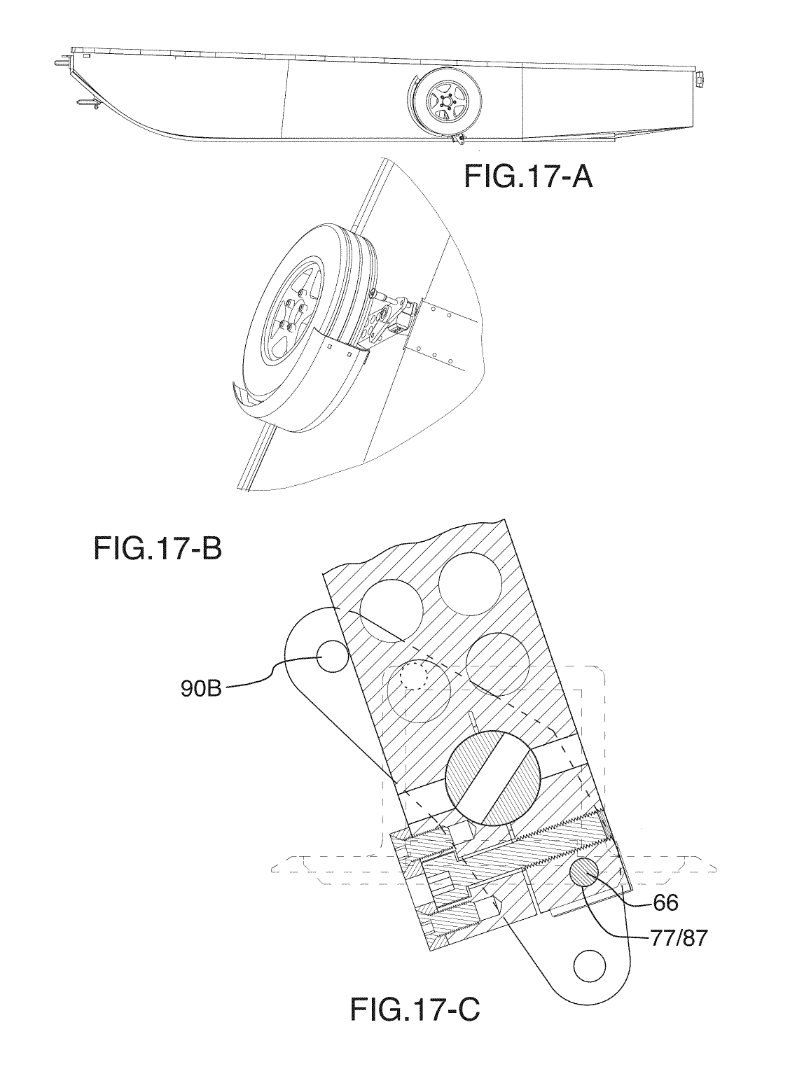

The quick release pin can then be reinserted, as indicated in FIGS. 17A-17C, to lock the arm in the water configuration.

Finally, the bolt can be tightened, to draw the forks together, as indicated in FIGS. 18A-18C.

The tongue and hitch arrangement defines means for coupling the hull to a vehicle.

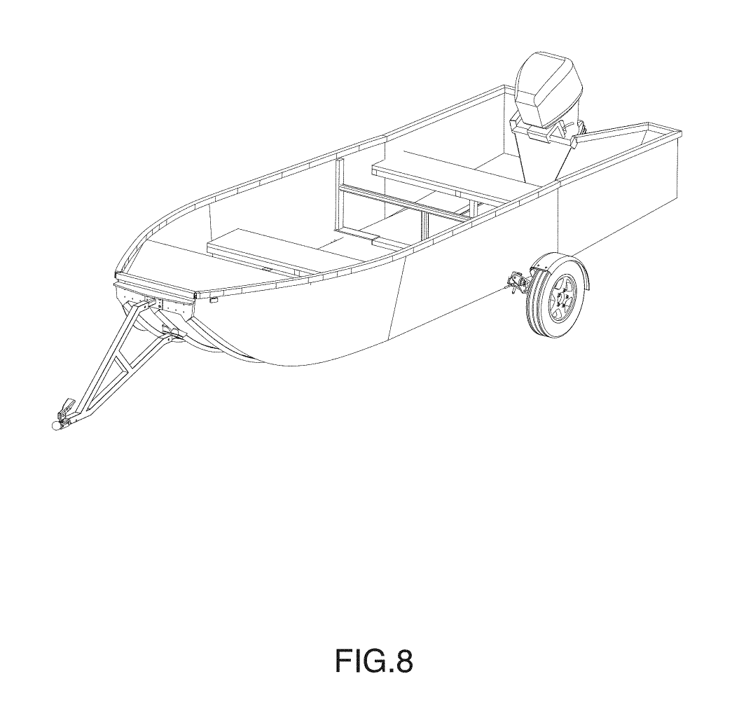

The tongue is releasably couplable to the hull by means of a pair of pins 92, as shown by the sequence of FIGS. 1, 8, and terminates in a towing ball receiver 94.

The hitch arrangement has a square tube end 96 adapted to be received by a conventional hitch receiver and carries a towing ball 98 and a winch 100.

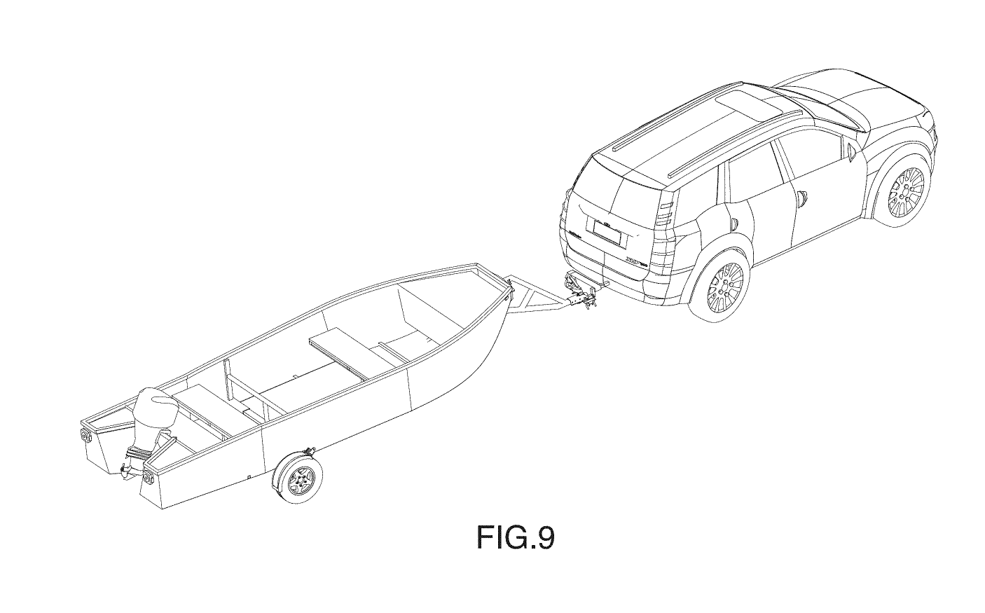

In use for towing, the tongue is coupled to the hull, the hitch arrangement is coupled to the hitch receiver and the towing ball is received by the towing ball receiver, all as shown in FIGS. 9,10.

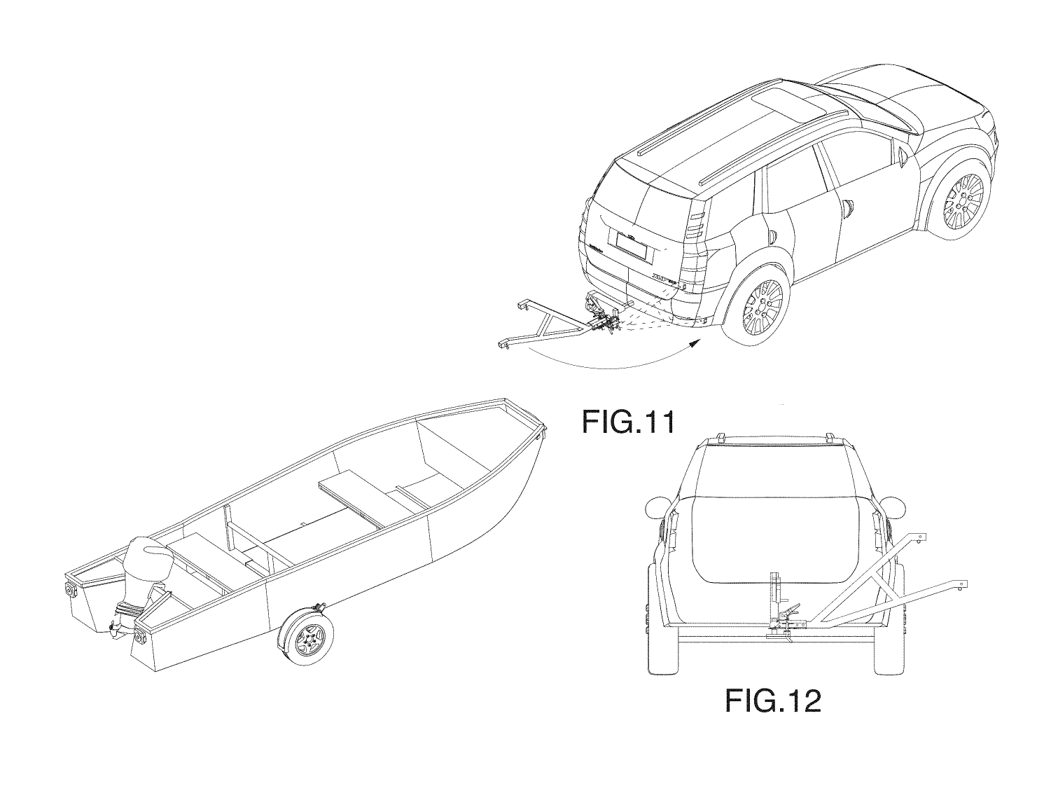

For boating, the tongue can be decoupled from the boat, as indicated by the sequence of FIGS. 9, 11. If the boat is to be returned to the same location for towing, the tongue can be left coupled to the vehicle and pivoted against the vehicle, as shown in FIG. 12. If the boat may be towed by another vehicle in another location, the tongue can be uncoupled from both the vehicle and the boat and transported in the boat to such other location.

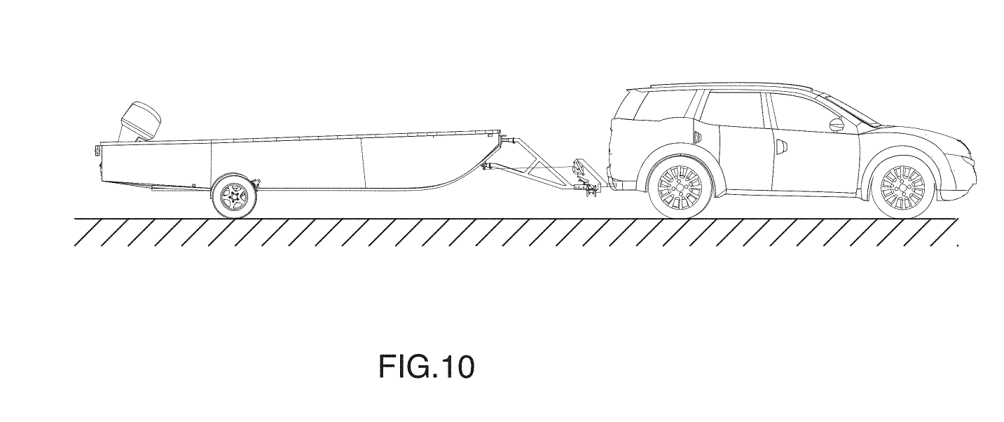

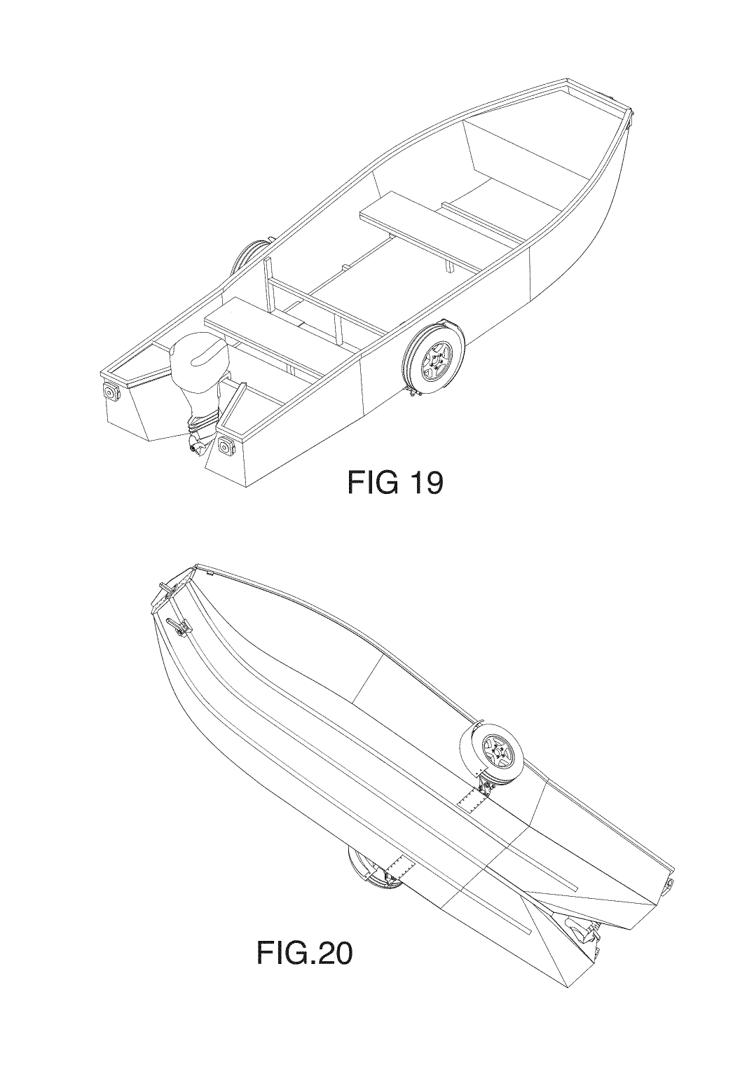

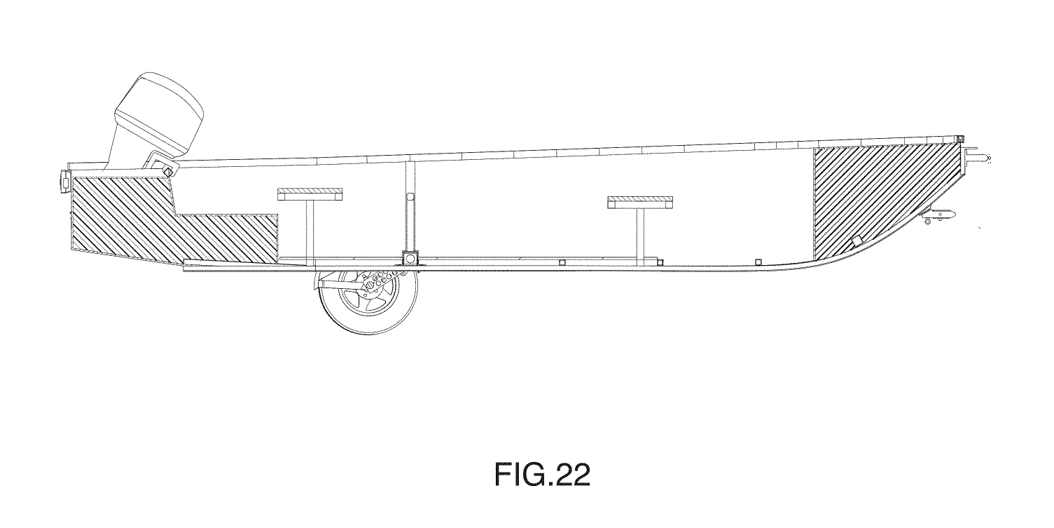

Persons of ordinary skill will readily appreciate the aforedescribed structure has great advantage, in that it is towable without the need of a trailer, is relatively easy to convert between towing and boating configurations, is relatively inexpensive to manufacture, is relatively robust in operation, is relatively lightweight, handles relatively well in the water and can service as a utility trailer. In this regard, although not shown, it will be understood that the hull, wheel assemblies and seats are sized, dimensioned and otherwise adapted to permit, among other things, a substantial load to be carried, including but not limited to sheets of plywood that can be laid, flat, on the intermediate seats.

Whereas a specific structure is shown in FIGS. 1-24, it will be evident that variants are possible.

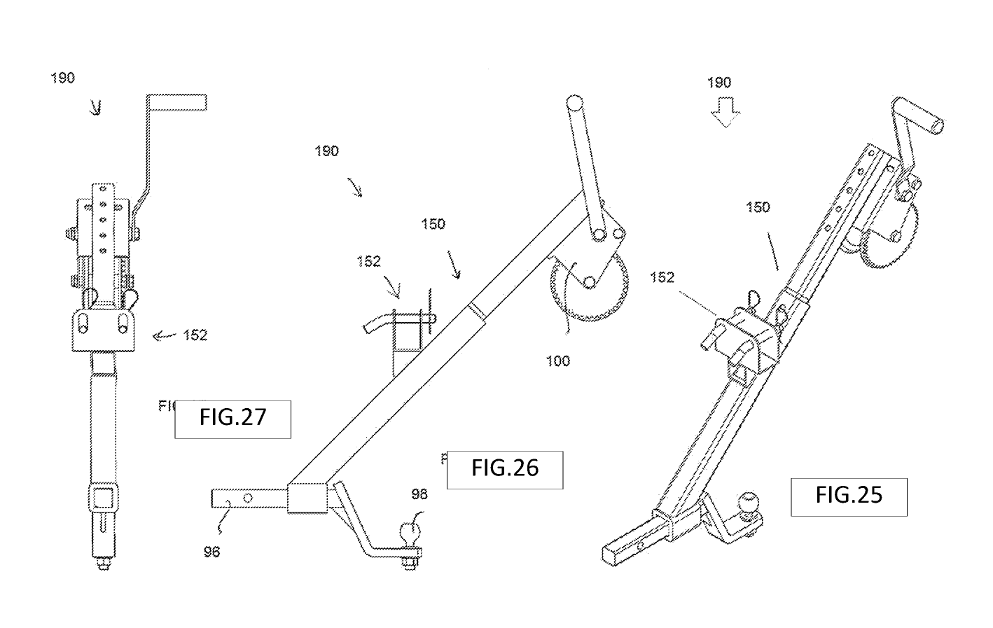

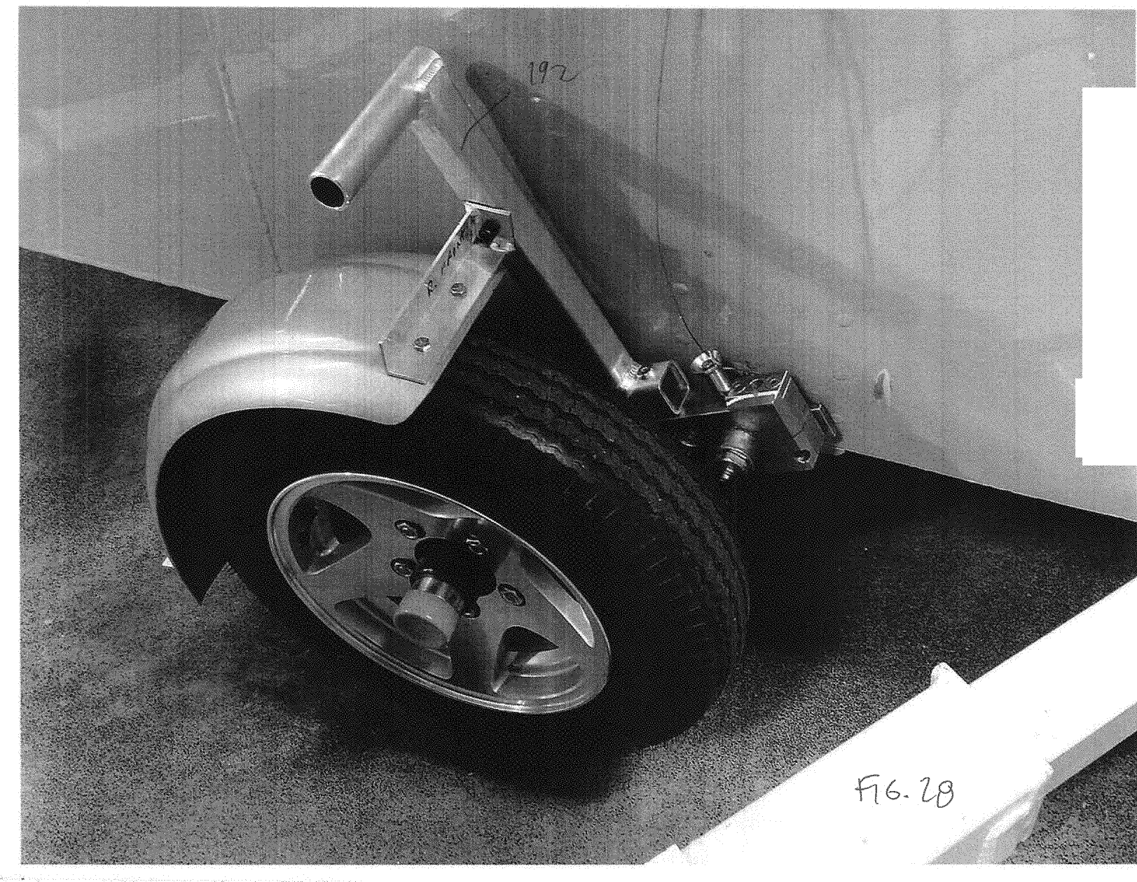

One such variant 190 is shown in FIGS. 25-27. This structure 190 functions similar to the hitch arrangement 26 of FIG. 1, in that it continues to carry a towing ball 98 and a winch 100 and has a square tube end 96 adapted to be received by a conventional hitch receiver. However, in this variant, the winch 100 is releasably coupled to the remainder of the structure by means of a post-socket connection 150, thereby to enable the winch to be secured against theft, and the structure further carries a receiver 152 for releasable receipt (not shown) of the tongue 24.

FIG. 28 shows another variant, this time of the structure of encircled area 128 of FIG. 1. In this variant, a handle 192 is coupled to the arm 68. In operation, the apparatus is again hauled in the manner of a trailer to the desired embarkation point whereupon bolt 64 is loosened, as previously described. Thereafter, the apparatus is caused to enter the water. Thence, pin 66 is removed, to decouple the arm 68, thereby to enable the arm 68 and wheel to be removed and stored, for example, in the boat. This variant has some advantage in that it removes the wheel from exposure to the water, which allows the boat to travel more quickly in the water. It will be understood that, in this variant, the arm does not rotate between the towing configuration and the water configuration; rather, the arm is remote from the shaft in the water configuration.

Yet other variations are possible. Accordingly, the invention should be understood to be limited only by the appended claims, purposively construed.

1. A system comprising:
a boat hull;
a pair of wheels;
for each wheel, an arm to which said each wheel is rotatably mounted, the arm being movable between
a towing configuration, wherein, when operatively positioned, the hull is supported for rolling movement on the wheels when dragged from the bow, and
a water configuration, wherein, when operatively positioned, the wheels
are alongside the hull
means for coupling the hull to a vehicle.

2. The system according to claim 1, wherein each arm is mounted to a shaft and rotates about the shaft for movement between the towing and water configuration.

3. The system according to claim 2, wherein the shaft extends from and is securely gripped by an elastic member.

4. The system according to claim 3, wherein the elastic member is releasably coupled to the hull.

5. The system according to claim 2, further comprising a pin for each arm and wherein
the shaft has an aperture defined therethrough;
the arm has a throughbore defined therethrough,
the throughbore being aligned with the aperture when the arm is in the towing configuration and when the arm is in the water configuration; and
the pin extends through througbore and the aperture when the arm is in the towing configuration and when the arm is in the water configuration.

6. The system according to claim 5, wherein the pin is a quick release ball lock pin.

7. The system according to claim 2, further comprising a threaded bolt for each arm and wherein
the arm has an end portion in which the bore is defined and a slot that extends through the bore to define a pair of forks;
the arm portion has a threaded socket in receipt of the bolt;
in the towing and water configuration, the forks are held relatively near to one another by the bolt and the shaft is frictionally gripped by the bore;
the bolt is loosened for movement of the arm between the towing and water configuration.

8. The system according to claim 1, wherein the means for coupling the hull to a vehicle includes: a tongue that is releasably couplable to the hull and that terminates in a towing ball receiver.

9. The system according to claim 8, wherein the means for coupling the hull to a vehicle further includes: a carrier that is adapted to be received by a hitch receiver and that carries a towing ball.

10. The system according to claim 9, wherein the carrier further comprises a winch.

11. A system comprising:
a boat hull;
a pair of wheels;
for each wheel, an arm to which said each wheel is rotatably mounted, the arm being movable between
a towing configuration, wherein, when operatively positioned, the hull is supported for rolling movement on the wheels when dragged from the bow, and
a water configuration;
means for coupling the hull to a vehicle; and
a threaded bolt for each arm, wherein: each arm is mounted to a shaft; the arm has an end portion in which the bore is defined and a slot that extends through the bore to define a pair of forks; the arm portion has a threaded socket in receipt of the bolt; in the towing configuration, the forks are held relatively near to one another by the bolt and the shaft is frictionally gripped by the bore; and the bolt is loosened for movement of the arm between the towing and water configuration.
